(19) United States
(12) Patent Application Publication
(10) Pub. No.: US 2013/0022934 A1
(43) Pub. Date: Jan. 24, 2013

(54) WAX-RECOVERY APPARATUS

(71) Applicant: SHAO-KAI PEI, Tu-Cheng (TW)

(72) Inventor: SHAO-KAI PEI, Tu-Cheng (TW)

(73) Assignee: HON HAI PRECISION INDUSTRY CO., LTD., Tu-Cheng (TW)

(21) Appl. No.: 13/406,713

(22) Filed: Feb. 28, 2012

(30) Foreign Application Priority Data
Jul. 19, 2011 (TW) 100125402

(51) Int. Cl. F27D 3/00

(52) U.S. Cl. 432/230

(57) ABSTRACT

A wax-recovery apparatus for collecting wax from one or more composite columns of glass lenses stuck together using wax. The wax-recovery apparatus includes a first conveyer, at least one holding mechanism, a heating device and a controller. The first conveyer includes a first conveyer belt having a carrying surface. The heating device is assembled adjacent to the carrying surface for heating the carrying surface and melting the wax. The controller is connected with the holding mechanism and the first conveyer for controlling the holding mechanism and the first conveyer to periodically work.

### BACKGROUND

1. Technical Field

The present disclosure generally relates to a wax-recovery apparatus.

2. Description of Related Art

In order to be assembled into a circular lens barrel, a plurality of square shaped glass sheets have to be rolled into circular pieces. These square shaped glass sheets are stacked up coaxially and adhered or bonded to each other using wax before the circular rolling process. After the circular rolling process, all the glass sheets become circular in shape, and remain stacked up coaxially and stuck or bonded together, thereby forming a substantially cylindrical composite column. Finally, the stacked cylindrical composite column is placed into a high temperature environment, for dissolving the wax, and thereby obtaining a plurality of distinct circular glass disks or sheets. Since the composite column is generally placed into the high temperature environment manually, it is time-consuming, and the operator has to work under hazardous environment.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure.

FIG. 1 shows a structural view of an embodiment of a wax-recovery apparatus.

FIG. 2 shows a partial enlarged view of a circled portion II of the wax-recovery apparatus of FIG. 1.

FIG. 3 shows an enlarged view of a circled portion III of the wax-recovery apparatus of FIG. 1.

### DETAILED DESCRIPTION

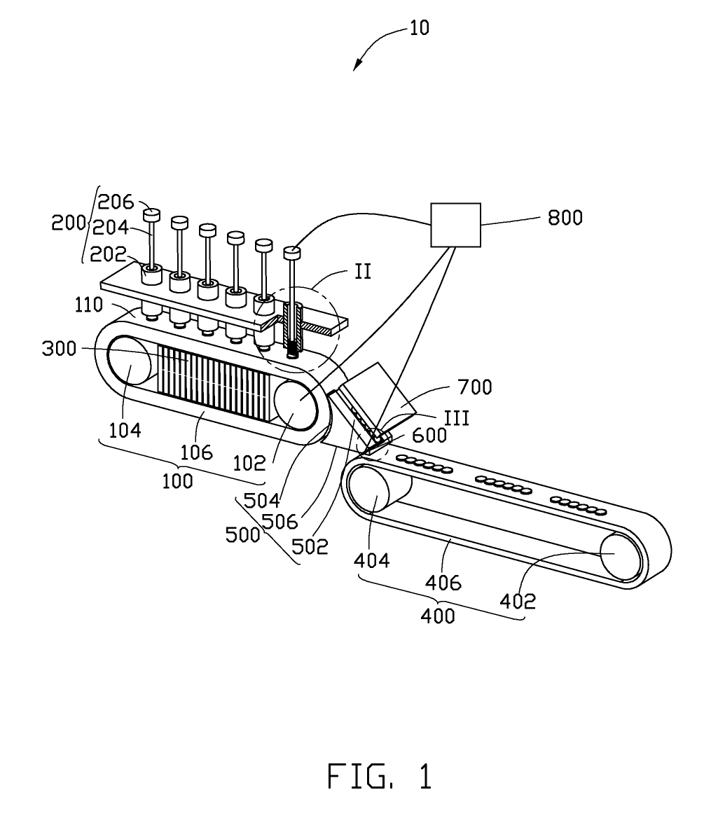

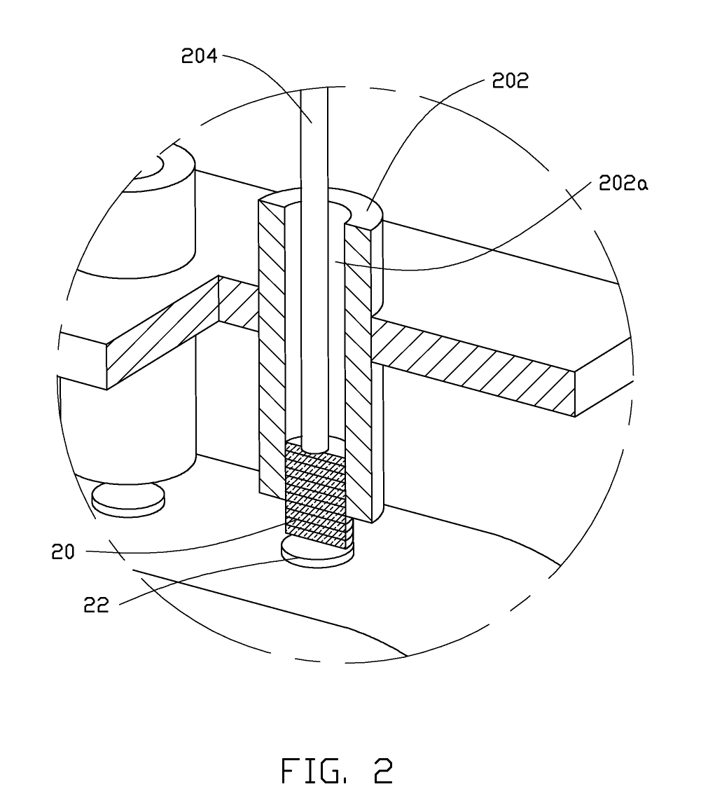

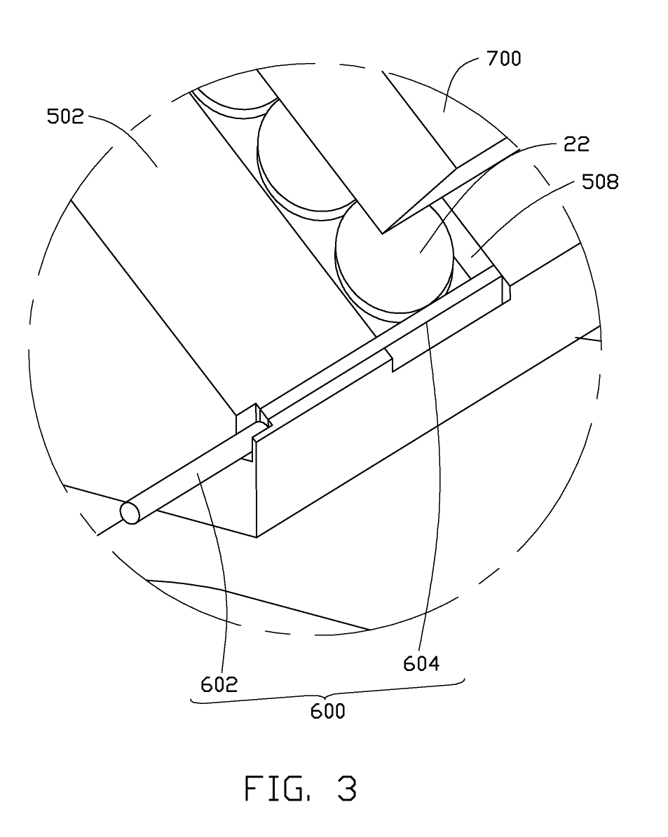

Referring to FIGS. 1 through 3, an embodiment of a wax-recovery apparatus 10 is shown for recovering wax from a number of composite columns 20. In the illustrated embodiment, each composite column 20 is substantially cylindrical and includes of a plurality of circular glass sheets 22 stacked up coaxially and adhered or bonded to each other using wax. The wax-recovery apparatus 10 includes a first conveyer 100, a plurality of holding mechanisms 200, a heating device 300, a second conveyer 400, a connecting mechanism 500, a stopper 600, an air blowing device 700 and a controller 800.

The first conveyer 100 includes a first drive wheel 102, a first driven wheel 104, and a first conveyer belt 106 tightly sleeved on the first drive wheel 102 and the first driven wheel 104. The first conveyer belt 106 together with the first driven wheel 104 is driven to rotate by the first drive wheel 102. The first conveyer belt 106 has an outer carrying surface 110. The first conveyer belt 106 is made of heat conductive material with good thermal conductivity. In the illustrated embodiment, the first conveyer belt 106 has a melting point above 100 degrees Celsius.

The plurality of holding mechanisms 200 are all mounted above the outer carrying surface 110 of the first conveyer belt 106, and arranged at a plurality of intervals along a conveying direction of the first conveyer belt 106 of the first conveyer 100. Each holding mechanism 200 includes a cylinder 202, a pushing rod 204 slidably assembled with the cylinder 202, and a drive unit 206. The cylinder 202 is hollow and includes an axial receiving hole 202a. One end of the pushing rod 204 is inserted into the receiving hole 202a of the cylinder 202 for pressing the composite column 20 toward the first conveyer belt 106 side. The opposite other end of the pushing rod 204 is assembled with the drive unit 206 and positioned away from the first conveyer belt 106. The drive unit 206 is mounted to a distal end of the pushing rod 204 and is configured for driving the pushing rod 204 to slide within the axial receiving hole 202a of the cylinder 202, thereby pressing the composite column 20 toward the first conveyer belt 106 side. An inner dimension of the receiving hole 202a allows for a clearance for accommodating the outer dimension of the composite column 20, thus the composite column 20 can be received within the receiving hole 202a. As the composite column 20 is received within the corresponding receiving hole 202a of the cylinder 202, the static friction generated between the inner surface of the receiving hole 202a and the outer peripheral surface of the composite column 20 is enough to adequately hold the composite column 20 up in place, thus the composite column 20 can stay held up within the receiving hole 202a of the cylinder 202 if there is no other downward force being exerted on the composite column 20 besides force of gravity.

The heating device 300 is assembled between the first drive wheel 102 and the first driven wheel 104, and the first conveyer belt 106 surrounds the heating device 300. The heating device 300 is capable of heating the corresponding outer carrying surface 110 of the first conveyer belt 106 to a temperature in a range from 60 to 80 Celsius degrees, and the heated outer carrying surface 110 of the first conveyer belt 106 then heats the corresponding composite columns 20 to thereby melt the wax to separate the circular glass sheets 22 of the composite columns 20. The portion or distance of the first conveyer belt 106 which is heated is at least as long as the overall length of the plurality of holding mechanisms 200.

The second conveyer 400 is assembled adjacent to the first conveyer 100 for receiving the separated circular glass sheets 22 sent from the first conveyer 100, and transferring the circular glass sheets 22 to a next in line work station (not shown). In the illustrated embodiment, the second conveyer 400 is assembled adjacent to the first drive wheel 102 end of the first conveyer 100, and is located below the first conveyer 100. The second conveyer 400 includes a second drive wheel 402, a second driven wheel 404, and a second conveyer belt 406. The second conveyer belt 406 is tightly sleeved on the second drive wheel 402 and the second driven wheel 404. In use, the second conveyer belt 406 together with the second driven wheel 404 are driven to rotate by the second drive wheel 402. The second conveyer belt 406 also has an outer carrying surface (not shown in figures).

The connecting mechanism 500 is substantially wedge-shaped and is assembled between the first conveyer 100 and the second conveyer 400 for thereby connecting the first conveyer 100 and the second conveyer 400 together. The connecting mechanism 500 includes an inclined guiding surface 502, an arc-shaped connecting surface 504 immediately adjacent to the first drive wheel 102 end of the first conveyer 100, and a horizontal bottom surface 506. The inclined guiding surface 502 is configured for gathering from, and connecting to, the carrying surface 110 of the first conveyer 100 and the carrying surface of the second conveyer 400. A sliding slot 508 is recessed from the inclined guiding surface 502 for guiding and sending the circular glass sheets 22 from the first conveyer belt 106 to the second conveyer belt 406. The width of the sliding slot 508 is slightly greater than the diameter of the circular glass sheet 22, such that the circular glass sheet 22 can freely slide down the sliding slot 508.

The stopper 600 is mounted adjacent to the lower end of the sliding slot 508 and positioned away from the first conveyer 100 for periodically blocking or preventing the circular glass sheets 22 from sliding down the sliding slot 508. In the illustrated embodiment, the stopper 600 includes an air cylinder 602 and a piston rod 604 driven by the air cylinder 602. The air cylinder 602 is mounted adjacent to the second conveyer 400 and positioned beside the lower end of the sliding slot 508. The piston rod 604 is slidably assembled with the air cylinder 602 along a direction perpendicular to the lengthways direction of the sliding slot 508, such that, the piston rod 604 is capable of being driven to slide or move across the sliding slot 508, for periodically blocking or preventing the circular glass sheets 22 from sliding along down the sliding slot 508. Specifically, the piston rod 604 is capable of being driven to stop at a first position to one side of the sliding slot 508 and to stop at a second position across or within the sliding slot 508.

The air blowing device 700 is mounted adjacent to and positioned above the inclined guiding surface 502, for blowing high pressure gas toward the guiding slot 508 of the inclined guiding surface 502.

The controller 800 is connected with the first drive wheel 102 of the first conveyer 100, the drive unit 206 and the air cylinder 602, for controlling the first drive wheel 102, the drive unit 206 and the air cylinder 602 to periodically work or operate. In the illustrated embodiment, the first drive wheel 102 is controlled to rotate at intervals between a preset heating time by the controller 800 together with the first conveyer belt 106. The first conveyer belt 106 is thus driven to move a length of at least half the total length of the first conveyer belt 106. The air cylinder 602 is also controlled by the controller 800 to work at intervals between a preset transmitting time, thereby driving the piston rod 604 to move, and finally stop at the aforementioned first position; and then the piston rod 604 is further driven to work at intervals between the preset heating time, thereby driving the piston rod 604 to slide to the second position within the sliding slot 508. The drive unit 206 is driven to work between intervals of the preset heating time plus a preset transmitting time, thereby driving the pushing rod 204 to push the composite column 20 positioned within the cylinder 202 to move toward onto the first conveyer belt 106. The preset heating time of the present disclosure is 2˜3 seconds, and the preset wheel rotation time is 5-6 seconds.

In use, several composite columns 20 are firstly placed into the cylinders 202. One end of each composite column 20 is positioned adjacent to or resists against the carrying surface 110 of the first conveyer 100, the opposite other end of each composite column 20 may be acted upon by the pushing rod 204. The heating device 300 heats the carrying surface 110 of the first conveyer belt 106 to the preset temperature of about 60˜80 Celsius degrees for melting the wax of each of the composite columns 20. After performing heating at the preset heating time, the wax of the lowest part of the composite column 20 (positioned closest to and connecting with the carrying surface 110) is melted, thus, the corresponding circular glass sheets 22 are separated from the composite columns 20 and dropped to or can be carried away by the carrying surface 110 of the first conveyer 100. The first conveyer belt 106 together with the first driven wheel 104 are then driven to rotate by the first drive wheel 102, the circular glass sheets 22 together with the melted wax on the carrying surface 110 are transferred and slided one by one into the sliding slot 508 of the connecting mechanism 500. The separated circular glass sheets 22 are now abutting against each other while staying in the sliding slot 508 in order, by means of the stopper 600. The air blowing device 700 blows high pressure gas toward the sliding slot 508, and thereby blowing away the melted wax on the top surface of the circular glass sheets 22. After a preset time, the piston rod 604 of the stopper 600 is pulled back for allowing the circular glass sheets 22 to slide to the carrying surface of the second conveyer belt 406. Meanwhile, the drive units 206 of the holding mechanisms 200 drive the corresponding pushing rods 204 to push down again on the composite columns 20 toward the first conveyer belt 106 side, thereby bringing the lowest ends of the composite columns 20 into contact with the carrying surface 110 of the first conveyer 100, and are ready for wax-recovery according to the aforementioned steps.

While various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A wax-recovery apparatus for recovering wax from a number of composite columns, the wax-recovery apparatus comprising:
a first conveyer comprising a first conveyer belt having a carrying surface for loading and transmitting the composite columns, wherein each composite column comprising a plurality of circular glass sheets that are stacked up coaxially and adhered to each other using wax;
at least one holding mechanism mounted above the carrying surface of the first conveyer for holding the composite column and pressing the composite column toward the carrying surface;
a heating device assembled adjacent to the carrying surface of the first conveyer for heating the corresponding carrying surface and melting the wax of the corresponding composite column; and
a controller connected with the at least one holding mechanism and the first conveyer, thereby controlling the at least one holding mechanism and the first conveyer to periodically work.

2. The wax-recovery apparatus of claim 1, wherein the first conveyer belt is made of heat conduction material, and a preset temperature of the first conveyer belt is about 60˜80 degrees Celsius, for facilitating the melting of the wax of the composite column, thereby separating the circular glass sheet from the composite column.

3. The wax-recovery apparatus of claim 2, wherein the first conveyer belt has a melting point above 100 degrees Celsius.

4. The wax-recovery apparatus of claim 1, wherein the first conveyer comprises a first drive wheel, a first driven wheel, and the first conveyer belt, the first conveyer belt is tightly sleeved on the first drive wheel and the first driven wheel; the heating device is assembled between the first drive wheel and the first driven wheel, and surrounded by the first conveyer belt.

5. The wax-recovery apparatus of claim 4, wherein the holding mechanism comprises a cylinder, a pushing rod slidably assembled with the cylinder, and a drive unit, the cylinder is hollow shaped and defines an axial receiving hole through the cylinder axially for holding and receiving the composite column; one end of the pushing rod is inserted into the receiving hole of the cylinder for resisting against the corresponding composite column toward the first conveyer belt side, the drive unit is mounted to the opposite other end of the pushing rod for driving the pushing rod to slide within the receiving hole of the cylinder.

6. The wax-recovery apparatus of claim 5, wherein an inner dimension of the receiving hole allows a clearance for accommodating the outer dimension of the composite column, as the composite column is received within the corresponding receiving hole of the cylinder, a static friction force generated between the inner surface of the receiving hole and the outer peripheral surface of the composite column is enough to hold the composite column up in place.

7. The wax-recovery apparatus of claim 6, further comprising a second conveyer assembled adjacent to the first conveyer and a connecting mechanism assembled between the first conveyer and the second conveyer thereby connecting the first conveyer and the second conveyer together.

8. The wax-recovery apparatus of claim 7, wherein the second conveyer is assembled adjacent to the first drive wheel end of the first conveyer, and is located below the first conveyer; the second conveyer includes a second drive wheel, a second driven wheel, and a second conveyer belt; the second conveyer belt is tightly sleeved on the second drive wheel and the second driven wheel; the connecting mechanism is wedge-shaped and includes an inclined guiding surface for connecting the carrying surface of the first conveyer and the carrying surface of the second conveyer, an arc-shaped connecting surface positioned toward the corresponding first drive wheel end, and a horizontal bottom surface.

9. The wax-recovery apparatus of claim 8, wherein the inclined guiding surface defines a sliding slot along a length direction of the inclined guiding surface, for guiding and sending the circular glass sheets from the first conveyer belt to the second conveyer belt.

10. The wax-recovery apparatus of claim 9, further comprising a stopper mounted adjacent to a distal end of the connecting mechanism and positioned away from the first conveyer for periodically blocking or preventing the circular glass sheets from sliding along down the sliding slot.

11. The wax-recovery apparatus of claim 10, wherein the stopper comprises an air cylinder and a piston rod driven by the air cylinder, the air cylinder is mounted adjacent to the second conveyer and positioned aside of the distal end of the sliding slot; the piston rod is slidably assembled with the air cylinder along a direction perpendicular to the length direction of the sliding slot, such that, the piston rod is capable of being driven to slide or move along a width direction of the sliding slot, for periodically blocking or preventing the circular glass sheets from sliding along down the sliding slot.

12. The wax-recovery apparatus of claim 10, further comprising an air blowing device mounted adjacent to and positioned above the inclined guiding surface, for blowing high pressure gas toward the corresponding guiding slot of the inclined guiding surface.

13. A wax-recovery apparatus for recovering wax of a plurality composite columns, the wax-recovery apparatus comprising:
a first conveyer comprising a first conveyer belt having a carrying surface for loading and transmitting the composite columns, wherein each composite column comprising a plurality of circular glass sheets that are stacked up coaxially and adhered to each other using wax;
a plurality of holding mechanisms mounted above the carrying surface of the first conveyer and arranged at intervals along a conveying direction of the first conveyer belt, for holding the composite columns and pressing the composite columns toward the carrying surface;
a heating device assembled adjacent to the carrying surface of the first conveyer for heating the corresponding carrying surface and melting the wax of the corresponding composite columns;
a second conveyer assembled adjacent to the first conveyer and located below the first conveyer;
a connecting mechanism assembled between the first conveyer and the second conveyer thereby connecting the first conveyer and the second conveyer together, the connecting mechanism defines a sliding slot for guiding and sending the circular glass sheets from the first conveyer belt to the second conveyer belt;
an air blowing device mounted adjacent to and positioned above the connecting mechanism, for blowing high pressure gas toward the corresponding guiding slot of the connecting mechanism; and
a controller connected with the holding mechanisms and the first conveyer, thereby controlling the holding mechanisms and the first conveyer to periodically work.

14. The wax-recovery apparatus of claim 13, wherein the first conveyer belt is made of heat conduction material, a preset temperature of the first conveyer belt is about 60˜80 degrees Celsius, for facilitating melting of the wax of the composite column, thereby separating the circular glass sheet from the composite column.

15. The wax-recovery apparatus of claim 14, wherein the first conveyer belt has a melting point above 100 degrees Celsius.

16. The wax-recovery apparatus of claim 13, wherein the first conveyer comprises a first drive wheel, a first driven wheel, and the first conveyer belt, the first conveyer belt is tightly sleeved on the first drive wheel and the first driven wheel; the heating device is assembled between the first drive wheel and the first driven wheel, and surrounded by the first conveyer belt.

17. The wax-recovery apparatus of claim 16, wherein each holding mechanism comprises a cylinder, a pushing rod slidably assembled with the cylinder, and a drive unit, the cylinder is hollow shaped and includes an axial receiving hole defined through the cylinder axially for holding and receiving the composite column; one end of the pushing rod is inserted into the receiving hole of the cylinder and resists against the corresponding composite column toward the first conveyer belt side, the drive unit is mounted to the opposite other end of the pushing rod for driving the pushing rod to slide within the receiving hole of the cylinder.

18. The wax-recovery apparatus of claim 13, further comprising a stopper mounted adjacent to a distal end of the connecting mechanism and positioned away from the first conveyer for periodically blocking or preventing the circular glass sheets from sliding along down the sliding slot.

19. The wax-recovery apparatus of claim 18, wherein the stopper comprises an air cylinder and a piston rod driven by the air cylinder, the air cylinder is mounted adjacent to the second conveyer and positioned beside the distal end of the sliding slot; the piston rod is slidably assembled with the air cylinder along a direction perpendicular to the length direction of the sliding slot, such that, the piston rod is capable of being driven to slide or move along a width direction of the sliding slot, for periodically blocking or preventing the circular glass sheets from sliding along down the sliding slot.
